(19) United States
(12) Patent Application Publication
(10) Pub. No.: US 2015/0369635 A1
(43) Pub. Date: Dec. 24, 2015

(54) ROTARY SPEED SENSOR

(71) Applicant: Infineon Technologies AG, Neubiberg (DE)

(72) Inventors: Bernhard SCHAFFER, Villach (AT); Friedrich RASBORNIG, Klagenfurt (AT); Christoph SCHROERS, Villach (AT)

(21) Appl. No.: 14/744,196

(22) Filed: Jun. 19, 2015

(30) Foreign Application Priority Data
Jun. 20, 2014 (CN) 201420331614.3

(51) Int. Cl. G01D 5/243; G01D 5/14

(52) U.S. Cl. CPC G01D 5/243; G01D 5/14

(57) ABSTRACT

The present utility model relates to a rotary speed sensor, comprising at least one sensor element (1), an analog signal processing block (2), a digital core (5) and a digital output end (10), wherein the analog signal processing block (2) comprises an analog signal regulating block (3) and an analog comparator (4), the digital core (5) comprises a digital signal processing means (7), wherein the digital core (5) additionally comprises a frequency detector (6), for detecting a frequency of a magnetic input signal of the rotary speed sensor, so that when the frequency is greater than a predetermined frequency, a time continuous signal path comprising the analog signal processing block (2) is formed, and when the frequency is smaller than a predetermined frequency, a time discrete digital signal path comprising the digital signal processing means (7) is formed.

### TECHNICAL FIELD

The present utility model relates to a rotary speed sensor.

### BACKGROUND ART

At present, rotary speed sensors based on Hall technology or xMR technology are subject to customer requirements regarding a large magnetic air gap and a corresponding precise switching duty cycle (40% to 60%—e.g. a ratio of Tₒₙ to T_{off} of output signal of 7 mA/14 mA), as well as an additional low output jitter application requirement for indirect tire pressure monitoring functionality (TPMF). In addition, there is another application requirement, namely (e.g. for uphill anti-retreat device functionality) the ability to realize the so-called 0 Hz capability.

However, up until now, no rotary speed sensor has been able to simultaneously meet the three requirements mentioned above at a reasonable cost in a single sensor product.

### Content of the Utility Model

Thus, the task on which the present utility model is based is to provide a rotary speed sensor that can overcome the above shortcomings in the prior art, i.e. simultaneously meet the three customer and application requirements mentioned above.

According to the present utility model, a rotary speed sensor is provided, comprising at least one sensor element for providing a speed signal, an analog signal processing block, a digital core for performing digital signal processing, and a digital output end, wherein the analog signal processing block comprises an analog signal regulating block and an analog comparator, the digital core comprises a digital signal processing means, wherein the digital core additionally comprises a frequency detector, for detecting a frequency of a magnetic input signal of the rotary speed sensor which is proportional to the speed signal, so that when the frequency is greater than a predetermined frequency, a time continuous signal path comprising the analog signal processing block is formed, and when the frequency is smaller than a predetermined frequency, a time discrete digital signal path comprising the digital signal processing means is formed.

Preferably, the digital output end is an asynchronous output end when the time continuous signal path is formed.

According to a preferred embodiment of the present utility model, the digital core additionally comprises a multiplexer which, when the frequency detected by the frequency detector is greater than a predetermined frequency, connects an output of the analog signal processing block to the digital output end, and when the frequency detected by the frequency detector is smaller than a predetermined frequency, connects an output of the digital signal processing means to the digital output end.

Preferably, when a time discrete digital signal path is formed, an output of the analog signal regulating block is inputted via an analog-to-digital converter into the digital signal processing means.

For example, the predetermined frequency may be 1 Hz.

For example, the frequency detector may be implemented by means of a frequency counter.

According to a preferred embodiment of the present utility model, the digital core additionally comprises an asynchronous logic circuit for executing untimed signal processing, the asynchronous logic circuit connecting the analog signal processing block to the multiplexer when a time continuous signal path is formed.

Preferably, the digital signal processing means comprises a digital offset control means, with an output of the digital offset control means being fed back to the analog signal processing block via an offset compensation digital-to-analog converter in order to maintain the switching duty cycle.

At the core of the present utility model is the integration on a single silicon chip of a combination of a time continuous signal processing scheme and a time discrete digital signal processing scheme, wherein:

the time continuous signal path is used for fast magnetic input signals. This path is optimized in terms of noise and jitter. This is realized by correspondingly determining the dimensions of the sensor element, analog signal processing block and asynchronous logic circuit. The time continuous signal path has low jitter (good), but is weaker in terms of offset/drift correction (bad), therefore the time continuous signal path is better for indirect tire pressure measurement.

the time discrete digital signal path is used for slow magnetic input signals. This path is optimized by means of precise time discrete digital offset control and a time discrete digital implementation switching threshold in order to maintain the switching duty cycle. The time discrete digital signal path is better in terms of offset/drift correction (good) but has high jitter (bad), therefore the time discrete digital signal path is better for an uphill anti-retreat device.

Switching between the two signal processing schemes is realized by correspondingly detecting a frequency f_{mag} of a magnetic input signal to be currently measured, wherein:

if the frequency f_{mag} is greater than a predetermined frequency, then a switch is made to using the analog signal processing scheme of the time continuous signal path, and if the frequency f_{mag} is smaller than a predetermined frequency, then a switch is made to using the digital signal processing scheme of the time discrete digital signal path.

According to the present utility model, during operation it is possible to switch between the time continuous signal path which is optimized in terms of jitter for fast magnetic input signals and the time discrete digital signal path for very slow magnetic input signals, according to the frequency of a magnetic input signal currently present which is proportional to a wheel speed of a vehicle. Thus, it is possible to switch between two different signal processing schemes on one product (a single silicon chip) according to the frequency of a magnetic input signal currently present which is proportional to a wheel speed of a vehicle, in order to provide corresponding expanded functionality.

Using such an expanded mixed scheme, it is possible on the one hand to satisfy the application requirement for a rotary speed sensor having additional low-jitter capability (such as indirect tire pressure monitoring functionality) with relatively low additional circuit expenditure (<5% additional chip area), and on the other hand 0 Hz capability can be realized (uphill anti-retreat functionality).

### DESCRIPTION OF THE ACCOMPANYING DRAWING

These and other features and advantages of the present utility model will become obvious through the following detailed description which refers to the accompanying drawing, wherein:

FIG. 1 is a schematic block diagram of the principles of a rotary speed sensor according to the present utility model.

### PARTICULAR EMBODIMENTS

Embodiments of the present utility model will now be described more comprehensively below with reference to the accompanying drawing which shows a functional block diagram of the present utility model. However, the present utility model may be specifically implemented in many different forms, and should not be interpreted as being limited to the embodiments expounded herein.

The terms used herein are merely intended to describe specific embodiments, not to limit the present utility model. As used herein, the singular forms “one”, “a” and “the” are intended to also include the plural form, unless clearly indicated otherwise in the context. It will also be understood that when the terms “comprise” and/or “contain” are used herein, this specifies the presence of the mentioned feature, entirety, element and/or component, but does not exclude the presence or addition of one or more other features, entireties, elements, components and/or groupings thereof.

Unless defined otherwise, all terms used herein (including technical and scientific terms) have the same meaning as that commonly understood by those skilled in the art. It will also be understood that the terms used herein should be interpreted as having a meaning consistent with their meaning in the background of the description and the relevant field, and should not be interpreted in an idealized or excessive form, unless clearly defined thus herein.

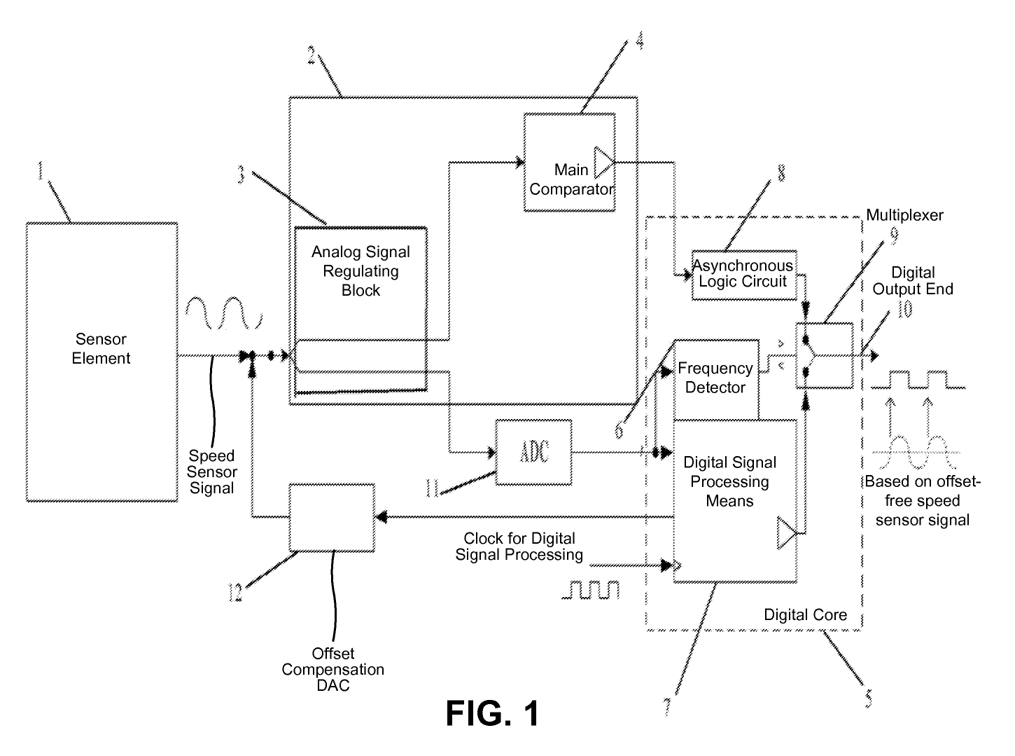

FIG. 1 shows schematically a block diagram of the principles of a rotary speed sensor according to the present utility model. The rotary speed sensor comprises at least one sensor element 1 for providing a speed signal, an analog signal processing block 2, a digital core 5 for performing digital signal processing, and a digital output end 10, wherein the analog signal processing block 2 comprises an analog signal regulating block 3 and a main comparator 4, and the digital core 5 comprises a digital signal processing means 7. The at least one sensor element 1 may for example be an anisotropic magnetoresistor (AMR)/giant magnetoresistor (GMR)/tunnel magnetoresistor (TMR) sensor or a Hall sensor. The main comparator 4 is for example a time continuous analog comparator. In an embodiment of the present utility model, the analog signal regulating block 3 may comprise an amplifier and a low-pass filter connected in series (not shown).

The digital core 5 additionally comprises a frequency detector 6, for detecting a frequency of a magnetic input signal of the rotary speed sensor which is proportional to the speed signal provided. When the frequency of the magnetic input signal is greater than a predetermined frequency, such as 1 Hz, a time continuous signal path comprising the correspondingly dimensioned analog signal processing block 2 is formed, wherein the time continuous path is optimized with regard to noise or jitter. The time continuous path may additionally comprise an asynchronous logic circuit 8, for executing untimed signal processing, in order to avoid quantizing noise. When the frequency of the magnetic input signal is smaller than a predetermined frequency, such as 1 Hz, a time discrete digital signal path comprising the digital signal processing means 7 is formed, wherein an output of the analog signal regulating block 2 is inputted to the digital signal processing means 7 via the analog-to-digital converter 11.

The digital core 5 additionally comprises a multiplexer 9 which, when the frequency detected by the frequency detector 6 is greater than a predetermined frequency, connects an output of the analog signal processing block 2 or asynchronous logic circuit 8 to the digital output end 10, wherein the digital output end 10 is an asynchronous output end in this case; and when the frequency detected by the frequency detector is smaller than a predetermined frequency, connects an output of the digital signal processing means 7 to the digital output end 10.

According to a preferred embodiment of the present utility model, the frequency detector 6 may be implemented by means of a frequency counter, which checks whether the detected frequency is lower than/higher than a corresponding threshold and additionally implements a switching delay (e.g. has f_{mag}=1 Hz±20%).

According to an embodiment of the present utility model, the digital signal processing means 7 may for example comprise a digital offset control means and a digital comparator (not shown), with an output of the digital offset control means being fed back to the analog signal processing block 2 via an offset compensation digital-to-analog converter 12, so that an output signal based on an offset-free speed signal can be provided at the digital output end 10.

According to an embodiment of the present utility model, when the time continuous signal path is formed, an output of the analog signal regulating block 3 is also digitalized by an analog-to-digital converter and is then transmitted to the digital signal processing means 7, in order to be further processed and to search for a minimum value and a maximum value of a signal. Using these two values, not only can a current magnetic field amplitude required for a “hidden” hysteresis function be determined, but an input signal offset can also be determined. This offset is caused on the one hand by an electrical offset of the analog signal processing block and/or an external magnetic field (e.g. pole wheel or gearwheel). Using the offset information, a switching signal can be re-centered by means of the offset compensation digital-to-analog converter, in order to obtain the desired 50% duty cycle or also to prevent offset/drift caused by temperature jumps which might lead to signal loss and therefore also to output switching loss. A digital offset compensation value from the digital signal processing means 7 to the offset compensation digital-to-analog converter 12 is only realized after conversion of the output at the digital output end 10 in order to prevent jitter caused by an offset algorithm.

According to an embodiment of the present utility model, a signal minimum value and maximum value are also searched for when the discrete digital signal path is formed, in order to determine an amplitude for ensuring a “hidden” hysteresis function, but clear offset regulation is not needed, because using current minimum value and maximum value information, and using a mathematical function such as (maximum value−minimum value)/2, it is always possible to determine optimum zero-crossing and therefore also determine a switching point. This corresponds to fast offset regulation, but does not contradict indirect tire pressure monitoring functionality, because the minimum magnetic frequency f_{mag}>10 . . . 100 Hz is restricted in application. Especially in cases of very slow frequency and small magnetic amplitude (a large air gap leads to a large distance from the pole wheel (Polrad) or gearwheel to the rotary speed sensor), fast offset change can lead to signal detection loss and therefore to output switching loss, and this then leads to slow detection of the current wheel speed. In this case, a completely digital time discrete signal path can execute offset correction which is superior to the time continuous analog signal path. Therefore this solution is demonstrated to be extremely feasible and usable.

Although the present utility model and advantages thereof have been described in detail above by means of exemplary embodiments, those skilled in the art should understand that a variety of substitutions and variations may be made to the present utility model without departing from the spirit and scope of the present utility model defined in the attached claims.

1. A rotary speed sensor, comprising at least one sensor element (1) for providing a speed signal, an analog signal processing block (2), a digital core (5) for performing digital signal processing, and a digital output end (10), wherein the analog signal processing block (2) comprises an analog signal regulating block (3) and an analog comparator (4), the digital core (5) comprises a digital signal processing means (7), wherein the digital core (5) additionally comprises a frequency detector (6), for detecting a frequency of a magnetic input signal of the rotary speed sensor which is proportional to the speed signal, so that when the frequency is greater than a predetermined frequency, a time continuous signal path comprising the analog signal processing block (2) is formed, and when the frequency is smaller than a predetermined frequency, a time discrete digital signal path comprising the digital signal processing means (7) is formed.

2. The rotary speed sensor as claimed in claim 1, wherein the digital output end (10) is an asynchronous output end when the time continuous signal path is formed.

3. The rotary speed sensor as claimed in claim 1, wherein the digital core (5) additionally comprises a multiplexer (9) which, when the frequency detected by the frequency detector (6) is greater than a predetermined frequency, connects an output of the analog signal processing block (2) to the digital output end (10), and when the frequency detected by the frequency detector is smaller than a predetermined frequency, connects an output of the digital signal processing means (7) to the digital output end (10).

4. The rotary speed sensor as claimed in claim 1, wherein when a time discrete digital signal path is formed, an output of the analog signal regulating block (3) is inputted via an analog-to-digital converter (11) into the digital signal processing means (7).

5. The rotary speed sensor as claimed in claim 1, wherein the frequency detector (6) is implemented by means of a frequency counter.

6. The rotary speed sensor as claimed in claim 1, wherein the digital core (5) additionally comprises an asynchronous logic circuit (8) for executing untimed signal processing, the asynchronous logic circuit connecting the analog signal processing block (2) to the multiplexer (9) when a time continuous signal path is formed.

7. The rotary speed sensor as claimed in claim 1, wherein the digital signal processing means (7) comprises a digital offset control means, with an output of the digital offset control means being fed back to the analog signal processing block (2) via an offset compensation digital-to-analog converter (12).
